(19) United States
(12) Patent Application Publication
(10) Pub. No.: US 2007/0268003 A1
(43) Pub. Date: Nov. 22, 2007

(54) SYSTEMS AND METHODS FOR MAXIMIZING THE OUTPUT OF A VEHICLE ALTERNATOR

(76) Inventors: Sergei F. Kolomeitsev, Orem, UT (US); Thomas James Gallagher, Orem, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/751,500

(22) Filed: May 21, 2007

Related U.S. Application Data
(60) Provisional application No. 60/802,469, filed on May 22, 2006.

(51) Int. Cl. H02P 9/00; H02H 7/06; H02P 11/00

(52) U.S. Cl. 322/33; 322/28; 322/37

(57) ABSTRACT

Systems and method for mixing the output of a vehicle alternator throughout any operating temperature range include a first temperature sensor for measuring a first temperature and a second temperature sensor for measuring a first temperature. A first temperature module compares the first temperature with a first temperature reference to determine a first temperature error, and to calculate a first duty cycle reference based on the first temperature error. A second temperature module compares the second temperature with a second temperature reference based on the second temperature error, and to calculate a second duty cycle reference based on the second temperature error. A duty cycle selection module selects the lesser of the first duty cycle reference or the second duty cycle reference as a maximum system duty cycle. A duty cycle control module regulates a field current of the vehicle alternator based on the maximum system duty cycle.

### CROSS-REFERENCE TO RELATED APPLICATIONS

This application claims the benefit of U.S. Provisional Application Ser. No. 60/802,469, filed May 22, 2006, which is incorporated herein by specific reference.

### BACKGROUND OF THE INVENTION

1. The Field of the Invention

The technology described in this patent document relates generally to vehicle alternators. More particularly, systems and methods are provided for maximizing the output of a vehicle alternator throughout its operating temperature range.

2. The Relevant Technology

High performance vehicle alternators are currently available that provide high efficiency, high output operation, particularly at low and medium speeds. In certain instances, however, the available output may be constrained by the thermal limits of the alternator. This can be particularly problematic when engine bay temperatures are increased, for instance as a result of countermeasures taken to comply with environmental noise pollution standards.

Cooling systems are typically used to help reduce the engine bay temperature and to dissipate heat generated by the alternator. In addition, to protect against alternator failure at high operating temperatures, many alternator systems apply fixed output limits based on measured temperature and, in some cases, alternator speed. Extensive testing is typically required to determine appropriate fixed limits. In many cases, however, the fixed limits do not provide the maximum possible output for a given operating temperature and speed. Moreover, if the engine bay temperature exceeds the predetermined rated maximum temperature, then the fixed limits are often set too high to adequately protect the alternator.

In accordance with the teachings described herein, systems and methods are provided for maximizing the output of a vehicle alternator throughout any operating temperature range. A first temperature sensor may be used to measure a first temperature, and a second temperature sensor may be used to measure a second temperature. A first temperature module may be used to compare the first temperature with a first temperature reference to determine a first temperature error, and to calculate a first duty cycle reference based at least in part on the first temperature error. A second temperature module may be used to compare the second temperature with a second temperature reference to determine a second temperature error, and to calculate a second duty cycle reference based at least in part on the second temperature error. A duty cycle selection module may be used to select the lesser of the first duty cycle reference and the second duty cycle reference as a maximum system duty cycle. A duty cycle control module may be used to regulate a field current of the vehicle alternator based at least in part on the maximum system duty cycle, such that the vehicle alternator is prevented from operating at a duty cycle in excess of the maximum system duty cycle.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a block diagram of an example system for maximizing the output of a vehicle alternator throughout its operating temperature range.

FIG. 2 is a block diagram illustrating an example system for maximizing the output of a vehicle alternator throughout its operating temperature and speed range.

FIG. 3 is a flow diagram depicting an example operation of a duty cycle control module.

FIG. 4 is a circuit diagram depicting an example alternator control system.

FIG. 5 is a block diagram illustrating another example system for maximizing the output of a vehicle alternator throughout its operating temperature and speed range.

FIG. 6 is a timing diagram depicting an example operation of the system for maximizing the output of a vehicle alternator.

### DETAILED DESCRIPTION OF THE PREFERRED EMBODIMENTS

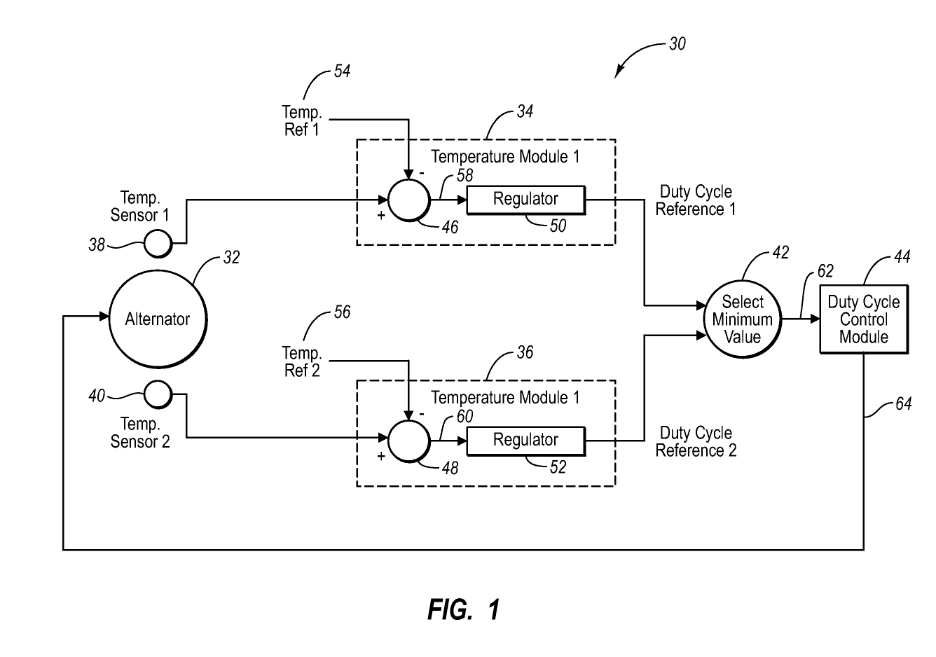

FIG. 1 is a block diagram of an example system 30 for maximizing the output of a vehicle alternator 32 throughout any operating temperature range. The system 30 includes two temperature modules 34, 36, each of which receives an input from a temperature sensor 38, 40. The system 30 also includes a duty cycle selection module 42 and a duty cycle control module 44.

The temperature sensors 38, 40 may measure the temperature at different positions relative to the alternator 32. For instance, the temperature sensors 38,40 may be attached in proximity to portions of the alternator 32, such as the end turns of the stator winding and/or the rectifier diodes, where operating temperature may be critical. One or more of the temperature sensors 38, 40 may also be positioned to measure the temperature of one or more other temperature-sensitive components that affect the operation of the alternator 32. For instance, if a temperature-sensitive microprocessor is used to implement one or more of the modules 34, 36, 42, 44 or to perform other control functions for the alternator 32, then a temperature sensor may also be positioned to measure the ambient temperature in proximity to the microprocessor. In a preferred embodiment, temperature sensors are located in proximity to at least the end points of the stator field winding and a system microprocessor.

The temperature modules 34, 36 each include a comparison element 46, 48 and a regulator element 50, 52. The comparison elements 46, 48 each receive a temperature signal from the respective temperature sensor 38, 40, and compare the temperature signal with a temperature reference 54, 56 to derive a temperature error 58, 60. The regulators 50, 52 use the temperature errors 58, 60 to calculate duty cycle references specific to each temperature sensor location.

In one example, the regulators 50, 52 may be implemented using proportional-integral-derivative (PID) controllers. The duty cycle references may, for example, be calculated using the following PID algorithm.

DutyCycleRef=Kp*temp_error+Ki∫(temp_error)dt+Kd*d(temp_error)/dt,

where “temp_error” is the temperature error 58, 60, and “Kp,” “Ki,” and “Kd” are gain parameters.

The duty cycle selection module 42 selects the lesser of the duty cycle references as the maximum system duty cycle 62, which is input to the duty cycle control module 44. The duty cycle control module 44 generates a control signal 64, based at least in part on the maximum system duty cycle limit. The control signal 64 regulates the field current of the alternator 32 such that the alternator 32 is prevented from operating at a duty cycle in excess of the maximum system duty cycle 62.

The temperature references for each temperature sensor location may be derived through experimentation. For instance, it has been determined that a temperature reference between about 125° C. and about 130° C. is appropriate for a temperature sensor located in proximity to a system microprocessor, and a temperature reference of about 240° C. is appropriate for a temperature sensor located near the end turns of a high temperature stator winding. It should be understood, however, that the temperature references may vary depending on the particular system components and configuration.

It should be further understood that the term “module,” as used herein, may include hardware, software or a combination of hardware and software. For instance, in one example, each of the modules 34, 36, 42, 44 depicted in FIG. 1 may be implemented using a single processing device. In other examples, one or more of the modules 34, 36, 42, 44 may be implemented using discrete logic circuitry and/or other circuit components. Other configurations are also possible.

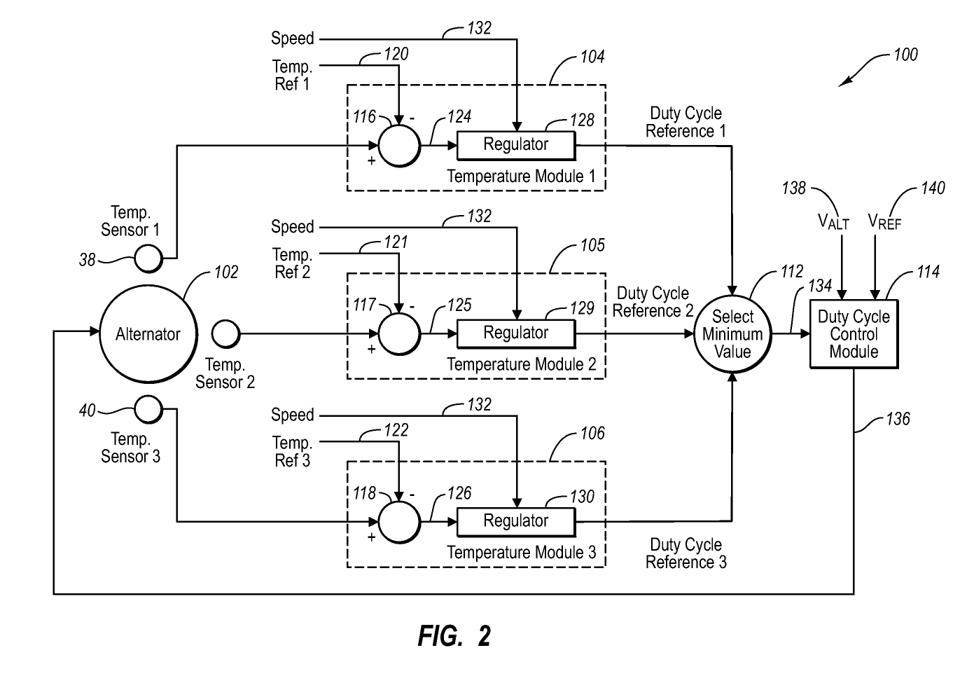

FIG. 2 is a block diagram illustrating an example system 100 for maximizing the output of a vehicle alternator 102 throughout any operating temperature and speed range. The system includes a plurality of temperature modules 104-106, each of which receives an input from a temperature sensor 108-110. The system 100 also includes a duty cycle selection module 112 and a duty cycle control module 114.

The temperature sensors 108-110 are located in proximity to temperature-sensitive portions of the alternator 102 and/or other system components, such as the alternator stator field winding and a system microprocessor. The temperature measurements from the sensors 108-110 are input to comparison elements 116-118 in the temperature modules 104-106, which compare the temperature measurement signals with predetermined temperature references 120-122 to derive a temperature error 124-126. The temperature error signals 124-126 are then input to regulator elements 128-130 along with a signal 132 that indicates the current operating speed of the alternator 102. The regulator elements 128-130 calculate duty cycle references for each temperature sensor location based on the alternator operating speed 132 and the temperature error 124-126. As illustrated, the regulator elements 128-130 may be implemented using PID controllers. The duty cycle references may, for example, be calculated using the following PID algorithm.

DutyCycleRef=Kp(p_speed)*temp_error+Ki(i_speed)∫(temp_error)dt+Kd(d_speed)*d(temp_error)/dt,

where “temp_error” is the temperature error 124-126; “p_speed,” “i_speed,” and “d_speed” are proportional, integral and derivative components of the speed signal 132; and “Kp,” “Ki,” and “Kd” are gain parameters.

The duty cycle references calculated by the temperature modules 104-106 are input to the duty cycle selection module 112, which selects the smallest duty cycle reference as the maximum system duty cycle 134 that is input to the duty cycle control module 114. The duty cycle control module 114 generates a control signal 136 based on both the maximum system duty cycle 134 and a comparison between the output voltage 138 of the alternator 102 and a predetermined reference voltage 140. The control signal 136 is used to regulate the field current of the alternator 102 such that the alternator operates at a duty cycle necessary to generate an output voltage 138 that is substantially equal to the voltage reference 140 so long as the duty cycle is less than the maximum system duty cycle 134. That is, the control signal 136 always prevents the alternator from operating at a duty cycle in excess of the maximum system duty cycle 134 in order to protect the system 100 from excessive operating temperatures.

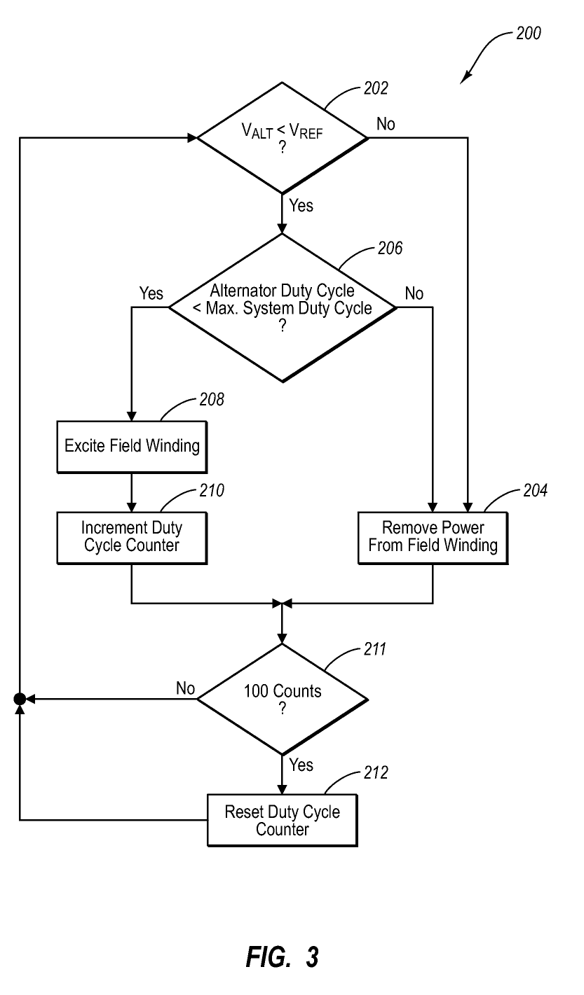

An example operation of a duty cycle control module is illustrated in FIG. 3. In step 202, the alternator output voltage (V_{ALT}) is compared with a predetermined reference voltage (V_{REF}). The reference voltage (V_{REF}) is the voltage set point (e.g., 14.2 V) at which the output of the alternator is to be regulated. The alternator output voltage (V_{ALT}) is the voltage measured across the alternator field winding. In other examples, however, the reference voltage (V_{REF}) may be compared to the battery voltage or to both the battery voltage and the alternator output voltage. If the alternator voltage (V_{ALT}) is greater than or equal to the reference voltage, then power is removed from the alternator field winding at step 204 in order to decrease the alternator duty cycle. Otherwise, if the alternator output voltage (V_{ALT}) is less than the reference voltage (V_{REF}), then the method proceeds to step 206.

In step 206, the duty cycle of the alternator output is compared with the maximum system duty cycle. If the alternator duty cycle is greater than or equal to the maximum system duty cycle, then power is removed from the field winding at step 204 in order to decrease the alternator duty cycle. Otherwise, if the alternator duty cycle is less than the maximum system duty cycle, then the field winding is excited at step 208 to increase the alternator duty cycle.

Steps 210-212 are used to control the timing of the duty cycle control module. A system microprocessor, which may be used to implement the duty cycle control module, is typically one of the most temperature-sensitive components of the alternator system. By operating the microprocessor at slower speeds, internal losses may be reduced and thus the maximum operating ambient temperature may be increased. To achieve this result, the sampling speed of the duty cycle control module may be set to perform the method depicted in FIG. 3 at every 1% duty cycle (e.g., 1 ms). The duty cycle control module thus performs the comparisons in steps 202 and 206 one hundred times for each duty cycle of the alternator. To control this timing operation, a duty cycle counter is incremented in step 210, and every 100 counts (step 211) the duty cycle counter is reset to zero (step 212).

It should be understood that other timing configurations for the duty cycle control module are also possible. For example, more than 100 counts may be included to improve resolution (e.g., one count every ½ duty cycle). Also, in other examples, the timing of the duty cycle control module may be independent of the alternator duty cycle.

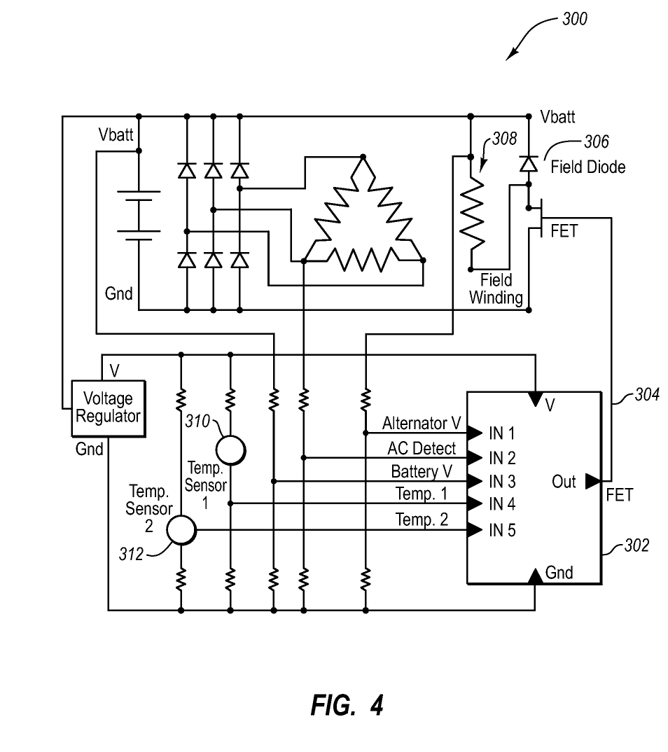

FIG. 4 is a circuit diagram depicting an example alternator control system 300. In this example, the control modules are implemented by a microprocessor 302. The microprocessor 302 may, for example, be used to implement the temperature modules, duty cycle selection module and duty cycle control module shown in FIG. 1 or FIG. 2. The microprocessor 302 controls the duty cycle of the alternator using a control signal 304 that is coupled to a FET 306. The current through the alternator field winding 308 is controlled by turning the FET on (to increase the duty cycle) and off (to decrease the duty cycle).

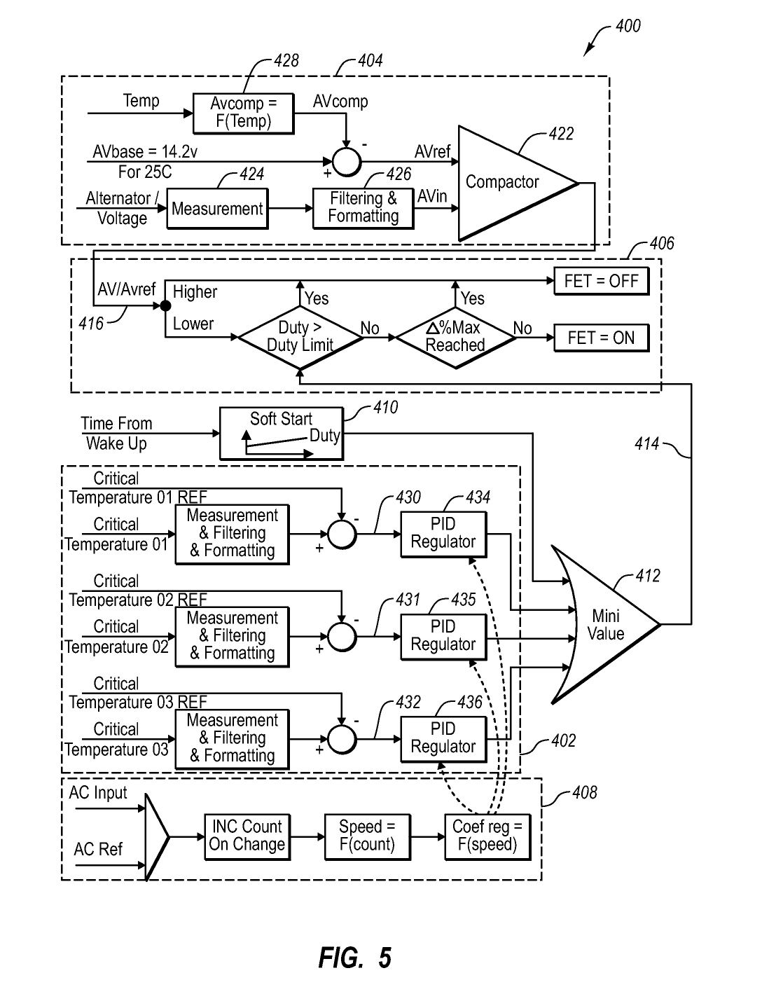

The inputs to the microprocessor 302 include temperature signals from two or more temperature sensors 310, 312, the battery voltage, the alternator output, and the AC stator output. The AC stator output may be used to determine the alternator speed, for example as shown in FIG. 5. The alternator speed, temperature signals and the alternator voltage and/or the battery voltage may be used to regulate the alternator duty cycle, as described above.

The use of a microprocessor to implement the alternator control modules may provide several advantages. For example, a microprocessor-based control system may enable the same regulation system to be used for various types of alternators. A microprocessor-based system may also provide other design flexibilities, such as the use of less external components and/or the use of less expensive PCB materials.

FIG. 5 is a block diagram illustrating another example system 400 for maximizing the output of a vehicle alternator throughout any operating temperature and speed range. The system includes a plurality of temperature modules 402, a voltage regulation module 404 and a duty cycle control module 406. Also included are an alternator speed calculation module 408, a soft-start module 410 and a duty cycle selection module 412.

In operation, the duty cycle control module 406 regulates the field current of the alternator based on a maximum system duty cycle 414 and a voltage regulation signal (AV/AVref) 416. The maximum system duty cycle 414 is determined by the duty cycle selection module 412, which selects the smallest duty cycle reference output from the temperature modules 402 and possibly from the soft-start module 410. The voltage regulation signal (AV/AVref) 416 is generated by the voltage regulation module 404 by comparing the alternator voltage 418 with a reference voltage (AVref) 410.

The voltage regulation module 404 includes a comparator 422, a voltage measurement element 424, a signal processing element 426, and a temperature compensation element 428. The alternator voltage input 418 may be received from the alternator field winding, and is input to the measurement element 424 to generate a voltage measurement signal. The voltage measurement signal is filtered and formatted by the signal processing element 426 and is input (AVin) to the comparator 422. The reference voltage (AVref) 420 input to the comparator 422 is generated by adjusting a base reference voltage (AVbase) to compensate for variations in ambient temperature. More specifically, a temperature compensation value (AVcomp) is calculated by the temperature compensation element 428 as a function of the measured ambient temperature (Temp). The base reference voltage (AVbase) is then adjusted by the temperature compensation value (AVcomp) to generate the reference voltage (AVref) 420. As shown, the preferred base reference voltage is 14.2V at 25°, however, other reference values may also be used.

The temperature modules 402 receive temperature signals (critical temperature 01, critical temperature 02 and critical temperature 03) from temperature sensors positioned at temperature-sensitive locations in the system. The temperature signals are processed to generate temperature measurements, which are compared to predetermined temperature references (critical temperature 01 REF, critical temperature 02 REF and critical temperature 03 REF) to derive temperature error values 430-432. The temperature errors 430-432 are input to PID controllers 434-436 along with a speed coefficient determined by the alternator speed calculation module 408. The PID controllers 434-436 calculate duty cycle references for each temperature sensor location based on the speed coefficient and the temperature error 430-432, for example using the PID algorithm described above with reference to FIG. 2.

The alternator speed calculation module 408 compares the AC output from the stator (AC_input) with an AC reference signal (AC_Ref) to identify a pulse count, and calculates the alternator speed as a function of the pulse count. The calculated alternator speed may then be processed to generate the speed coefficient, for example by putting the alternator speed value into a format expected by the PID controllers.

The soft-start module 410 may be used when the vehicle alternator is first activated to slowly ramp the alternator duty cycle to its operating level.

The duty cycle control module 406 controls the current through the alternator field winding by turning a switching circuit (e.g., a FET) on and off, for example as shown in FIG. 4. If the voltage regulation signal (AV/AVref) 416 indicates that the alternator voltage (AVin) is higher than the reference voltage (AVref), then the switching circuit (e.g., FET) is turned off to decrease the alternator duty cycle and thus reduce the alternator voltage. Otherwise, if the alternator voltage (AVin) is less than the reference voltage (AVref), then the duty cycle control module 406 compares the current duty cycle of the alternator with the maximum system duty cycle 414. If the alternator duty cycle is higher than the maximum system duty cycle 414, then the switching circuit (e.g., FET) is turned off to decrease the alternator duty cycle.

If the alternator duty cycle is not above the maximum system duty cycle 414, then the duty cycle control module 406 may also determine if the rate of change (A %) of the alternator duty cycle exceeds a predetermined limit. This helps to ensure that the duty cycle is not increased too quickly, for example when the alternator comes under a significantly increased load (e.g., heated seats are switched on). Only if all of these conditions are satisfied will the duty cycle control module 406 then turn on the switching circuit (e.g., FET) to increase the alternator duty cycle. In this manner, the duty cycle control module protects the system against thermal damage, while utilizing the maximum output capability of the alternator under any operating condition.

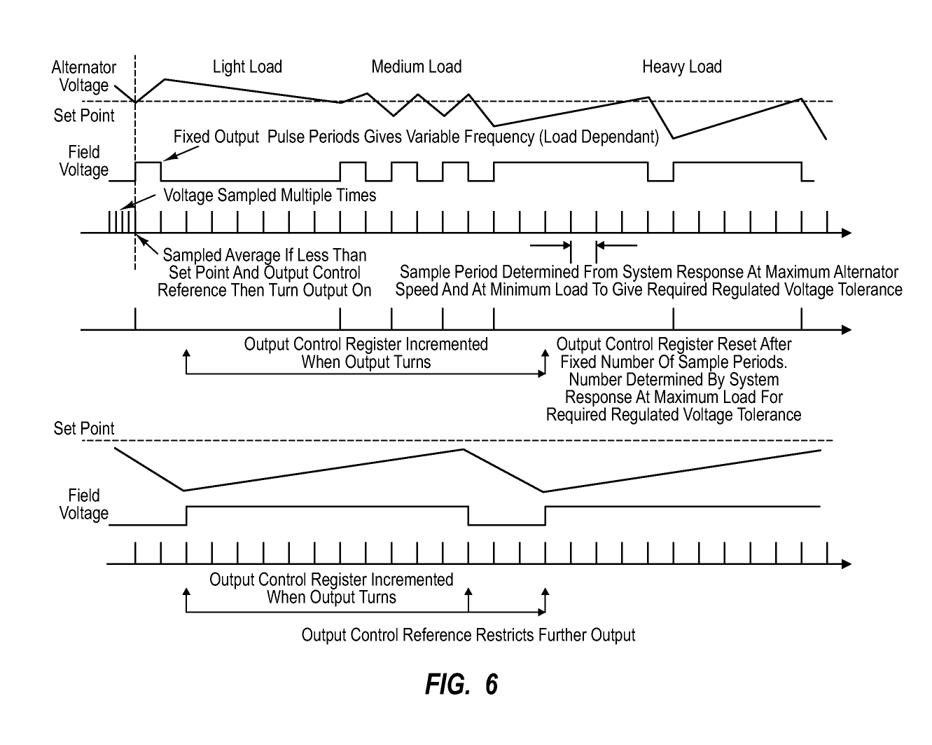

FIG. 6 is a timing diagram depicting an example operation of a system for maximizing the output of a vehicle alternator, as the system shown in FIG. 5. The timing diagram illustrates the dynamic nature of the duty cycle control, which may result in a non-periodic duty cycle, particularly at light and medium loads. This dynamic regulation differs from a typical fixed frequency regulator that varies the duty cycle ratio using an internal duty cycle control register.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A regulation system for a vehicle alternator, comprising:
a first temperature sensor for measuring a first temperature;
a second temperature sensor for measuring a second temperature;
a first temperature module that compares the first temperature with a first temperature reference to determine a first temperature error;
the first temperature module calculating a first duty cycle reference based at least in part on the first temperature error;
a second temperature module that compares the second temperature with a second temperature reference to determine a second temperature error;
the second temperature module calculating a second duty cycle reference based at least in part on the second temperature error;
a duty cycle selection module that selects the lesser of the first duty cycle reference and the second duty cycle reference as a maximum system duty cycle; and
a duty cycle control module that regulates a field current of the vehicle alternator based at least in part on the maximum system duty cycle, such that the vehicle alternator is prevented from operating at a duty cycle in excess of the maximum system duty cycle.

2. The regulation system of claim 1, wherein at least one of the first temperature and the second temperature is measured at a position relative to the vehicle alternator.

3. The regulation system of claim 2, wherein the first temperature sensor is positioned to measure an ambient temperature in proximity to a stator winding of the vehicle alternator.

4. The regulation system of claim 3, wherein the first temperature reference is between about 125° C. and about 130° C.

5. The regulation system of claim 2, wherein at least one of the first temperature sensor and the second temperature sensor is positioned to measure an ambient temperature in proximity to a rectifier diode of the vehicle alternator.

6. The regulation system of claim 1, wherein the first temperature is measured relative to a processing device that controls the vehicle alternator.

7. The regulation system of claim 6, wherein the first temperature reference is about 240° C.

8. The regulation system of claim 1, wherein the first temperature module calculates the first duty cycle reference as a function of the first temperature error and an operating speed of the alternator, and the second temperature module calculates the second duty cycle reference as a function of the second temperature error and the operating speed of the alternator.

9. The regulation system of claim 1, wherein the first temperature module and the second temperature module are implemented using a multi-channel proportional-integral-derivative (PID) controller.

10. The regulation system of claim 1, wherein:
the first temperature module includes a first comparison element that compares the first temperature with the first temperature reference to determine the first temperature error, and a first PID controller that calculates the first duty cycle reference as a function of the first temperature error; and
the second temperature module includes a second comparison element that compares the second temperature with the second temperature reference to determine the second temperature error, and a second PID controller that calculates the second duty cycle reference as a function of the second temperature error.

11. The regulation system of claim 1, wherein:
the duty cycle control module receives a voltage signal indicating an output voltage of the alternator and a voltage reference and compares the voltage signal with the voltage reference to determine a voltage error;
the duty cycle control module regulating the field current of the vehicle alternator based on the maximum system duty cycle and the voltage error, such that the vehicle alternator operates at a duty cycle necessary to generate an output voltage equal to the voltage reference so long as the duty cycle is less than the maximum system duty cycle.

12. The regulation system of claim 1, wherein the duty cycle control module regulates the field current of the vehicle alternator by opening and closing a switching circuit that is coupled in series with an alternator field winding.

13. The regulation system of claim 12, wherein the switching circuit includes a field-effect transistor (FET).

14. The regulation system of claim 1, wherein the duty cycle control module generates a control signal to regulate the field current of the vehicle alternator, and wherein the control signal is sampled by a clock signal that is proportional to an operating frequency of the vehicle alternator.

15. The regulation system of claim 14, wherein the duty cycle of the vehicle alternator is 100 ms and the clock signal includes a clock pulse every 1 ms.

16. The regulation system of claim 1, wherein the first temperature module, second temperature module, duty cycle selection module and duty cycle control module are all implemented using a single processing device.

17. The regulation system of claim 1, wherein the duty cycle control module further regulates the field current of the vehicle alternator to prevent the duty cycle of the vehicle alternator from increasing at a rate in excess of a predetermined maximum rate.

18. A method for maximizing a vehicle alternator system, comprising:
measuring a first temperature at a first position in the vehicle alternator system;
measuring a second temperature at a second position in the vehicle alternator system;
comparing the first temperature with a first temperature reference to determine a first temperature error;
calculating a first duty cycle reference based at least in part on the first temperature error;
comparing the second temperature with a second temperature reference to determine a second temperature error;
calculating a second duty cycle reference based at least in part on the second temperature error;
selecting the lesser of the first duty cycle reference and the second duty cycle reference as a maximum system duty cycle; and
regulating a field current of the vehicle alternator based at least in part on the maximum system duty cycle, such that the vehicle alternator is prevented from operating at a duty cycle in excess of the maximum system duty cycle.

19. The regulation system of claim 18, wherein the first temperature is measure in proximity to a stator winding of the vehicle alternator.

20. The regulation system of claim 19, wherein the first temperature reference is between about 125° C. and about 130° C.

21. The regulation system of claim 18, wherein the first temperature is measured in proximity to a rectifier diode of the vehicle alternator.

22. The regulation system of claim 18, wherein the first temperature is measured relative to a processing device that controls the vehicle alternator.

23. The regulation system of claim 22, wherein the first temperature reference is about 240° C.

24. The regulation system of claim 18, wherein the first duty cycle reference is calculated as a function of the first temperature error and an operating speed of the alternator, and the second duty cycle reference is calculated as a function of the second temperature error and the operating speed of the alternator.

25. The regulation system of claim 18, further comprising:
receiving a voltage signal indicating an output voltage of the alternator;
comparing the voltage signal with a voltage reference to determine a voltage error;
wherein the field current of the vehicle alternator is regulated based on the maximum system duty cycle and the voltage error, such that the vehicle alternator operates at a duty cycle necessary to generate an output voltage equal to the voltage reference so long as the duty cycle is less than the maximum system duty cycle.

26. The regulation system of claim 18, wherein the field current of the vehicle alternator is further regulated to prevent the duty cycle of the vehicle alternator from increasing at a rate in excess of a predetermined maximum rate.

27. A vehicle alternator system, comprising:
means for measuring a first temperature at a first position in the vehicle alternator system;
means for measuring a second temperature at a second position in the vehicle alternator system;
means for comparing the first temperature with a first temperature reference to determine a first temperature error;
means for calculating a first duty cycle reference based at least in part on the first temperature error;
means for comparing the second temperature with a second temperature reference to determine a second temperature error;
means for calculating a second duty cycle reference based at least in part on the second temperature error;
means for selecting the lesser of the first duty cycle reference and the second duty cycle reference as a maximum system duty cycle; and
means for regulating a field current of the vehicle alternator based at least in part on the maximum system duty cycle, such that the vehicle alternator is prevented from operating at a duty cycle in excess of the maximum system duty cycle.

28. The regulation system of claim 27, further comprising:
means for receiving a voltage signal indicating an output voltage of the alternator; and
means for comparing the voltage signal with a voltage reference to determine a voltage error;
wherein the field current of the vehicle alternator is regulated based on the maximum system duty cycle and the voltage error, such that the vehicle alternator operates at a duty cycle necessary to generate an output voltage equal to the voltage reference so long as the duty cycle is less than the maximum system duty cycle.
